(19) United States
(12) Patent Application Publication
(10) Pub. No.: US 2022/0276877 A1
(43) Pub. Date: Sep. 1, 2022

(54) METHOD AND APPARATUS FOR SEQUENCE PROCESSING, AND STORAGE MEDIUM

(71) Applicant: BEIJING XIAOMI MOBILE SOFTWARE CO., LTD., Beijing (CN)

(72) Inventors: Daniel POVEY, Beijing (CN); Haowen QIU, Beijing (CN)

(73) Assignee: BEIJING XIAOMI MOBILE SOFTWARE CO., LTD., Beijing (CN)

(21) Appl. No.: 17/351,450

(22) Filed: Jun. 18, 2021

(30) Foreign Application Priority Data
Feb. 26, 2021 (CN) 202110221055.5

(51) Int. Cl. G06F 9/448; G06F 9/48; G06F 16/22; G06F 16/28; G06T 1/20

(52) U.S. Cl. CPC G06F 9/4498; G06F 9/4881; G06F 16/2272; G06F 16/2264; G06F 16/288; G06T 1/20

(57) ABSTRACT

A sequence processing method can be applied to a graphics processor (GPU), and include: determining a sequence to be processed, which has an irregular tensor data structure; determining data structure information in the sequence to be processed, where the data structure information includes tensor dimensions and element information in tensors of each dimension; converting the irregular tensor data structure into a regular tensor data structure based on the tensor dimension and the element information; and processing the sequence to be processed based on the regular tensor data structure. The sequence with irregular tensor data structure can be processed on the GPU, so as to optimize the ability of GPU to process the sequence, speed up the processing process, and improve the efficiency of GPU to process the sequence.

### CROSS-REFERENCE TO RELATED APPLICATION

This application claims priority to Chinese Patent Application No. 202110221055.5 filed on Feb. 26, 2021, the disclosure of which is hereby incorporated by reference in its entirety.

### BACKGROUND

A neural network can be regarded as a parameterized complex nonlinear function, and its parameters are usually arrays with data structures as tensors. Neural networks can be used to handle sequence processing tasks such as speech recognition, handwritten character recognition, and natural language processing. Due to the limited algorithms that can be performed by a graphics processing unit (GPU), the efficiency of processing sequences is low that when performing sequence recognition tasks a central processing unit (CPU) is used for processing.

### SUMMARY

In order to solve issues in the field of computer technologies, the present disclosure provides a sequence processing method, a sequence processing device, and a storage medium.

According to the first aspect of the embodiments of the present disclosure, a sequence processing method is provided which is applied to a graphics processor or graphics processing unit (GPU), where the sequence processing method includes: determining a sequence to be processed, which has an irregular tensor data structure; determining data structure information in the sequence to be processed, where the data structure information includes tensor dimensions and element information in tensors of each dimension; converting the irregular tensor data structure into a regular tensor data structure based on the tensor dimension and the element information; and processing the sequence to be processed based on the regular tensor data structure.

According to some embodiments of the present disclosure, there is provided a sequence processing apparatus, including: a memory device, configured to store processor-executable instructions; and a processor, configured to: determine a sequence to be processed, and determine data structure information in the sequence to be processed, wherein the sequence to be processed has an irregular tensor data structure, and the data structure information includes tensor dimensions and element information in tensors of each dimension; convert the irregular tensor data structure into a regular tensor data structure based on the tensor dimension and the element information; and process the sequence to be processed, based on the regular tensor data structure.

According to some embodiments of the present disclosure, there is provided a computer-readable storage medium having stored thereon instructions for execution by a processor to implement a sequence processing method , applied to a graphics processor, comprising: determining a sequence to be processed, which has an irregular tensor data structure; determining data structure information in the sequence to be processed, where the data structure information includes tensor dimensions and element information in tensors of each dimension; converting the irregular tensor data structure into a regular tensor data structure based on the tensor dimension and the element information; and processing the sequence to be processed based on the regular tensor data structure.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this disclosure, illustrate embodiments consistent with the disclosure and, together with the description, serve to explain the principles of the disclosure.

FIG. 1 is a flowchart showing a sequence processing method according to some embodiments.

FIG. 2 is a flowchart showing a data structure converting process according to some embodiments.

FIG. 3 is a flowchart showing a sequence processing method according to some embodiments.

FIG. 4 is a schematic diagram showing changes of a finite state acceptor FSA according to some embodiments.

FIG. 5 is a flowchart showing a sequence processing method according to some embodiments.

FIG. 6 is a flowchart showing a sequence processing method according to some embodiments.

FIG. 7 is a block diagram showing a sequence processing apparatus according to some embodiments.

FIG. 8 is a block diagram showing another sequence processing apparatus according to some embodiments.

### DETAILED DESCRIPTION

Description will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods consistent with aspects related to the disclosure as recited in the appended claims.

In the field of machine learning and artificial intelligence, the neural network is trained through the machine learning tool system with sequence processing tasks such as speech recognition, handwritten character recognition, and natural language processing, and then relevant parameters in the neural network are adjusted such that the trained neural network can become the target model. The data structure of relevant parameters includes a tensor data structure. For example, the machine learning tool system may include the PyTorch system or the TensorFlow system.

Since GPU algorithms are not universal and only include related algorithms for processing regular tensor data structures, when performing sequence processing tasks, the sequence processing tasks to be executed by the GPU are transferred to the CPU for processing, and the algorithm in the CPU is used to perform the corresponding processing. After the CPU processing is completed, the CPU transfers the processing result to the GPU, and the GPU executes subsequent tasks. However, when processing in this way, sequence processing is too cumbersome, which affects its efficiency, so when related data is transferred between the CPU and GPU, the processing efficiency is likely to be too low, which in turn affects the user experience.

In view of this, the present disclosure provides a sequence processing method that can be applied to GPUs. For a sequence with an irregular tensor data structure, the irregular tensor data structure is converted into a regular tensor data structure, based on the data structure information included in the irregular tensor data structure. Based on the regular tensor data structure, the sequence to be processed is processed, and the ability of the GPU to process the sequence is optimized, such that the GPU is not restricted by the algorithm when executing the sequence processing task, thereby simplifying the sequence processing process and improving the efficiency of the GPU processing sequence.

In some examples, the sequence processing method provided by the present disclosure can be applied to any terminal that includes general-purpose graphical processing units (GPGPUs), and GPGPUs can also be understood as GPUs. In some embodiments, the types of terminals may include mobile terminals, such as mobile phones, tablets, smart TVs, smart speakers with screens, smart watches with screens, and iPods. In some other embodiments, the structure of the terminal may include a double-sided screen terminal, a folding screen terminal, a full-screen terminal, etc.

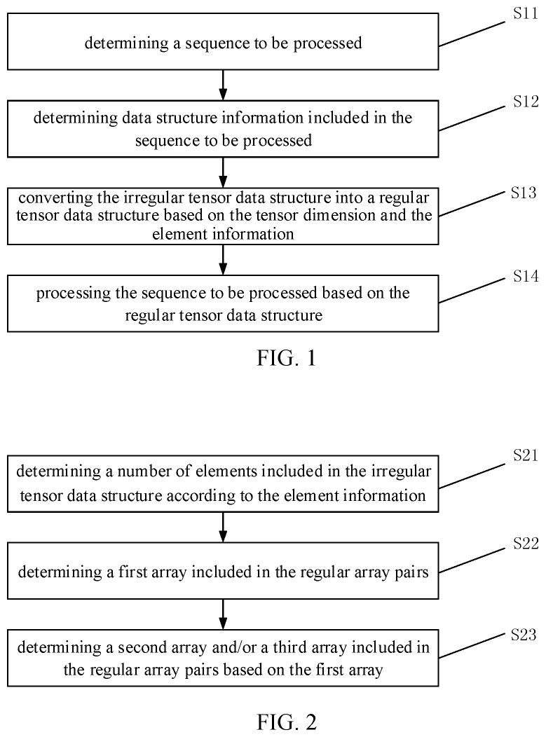

FIG. 1 is a flowchart showing a sequence processing method according to some embodiments. As shown in FIG. 1, the sequence processing method includes the following steps S11 to S14.

In step S11, the sequence to be processed is determined.

In some embodiments of the present disclosure, the data structure of the sequence may include a tensor data structure. Herein, the tensor data structure includes a regular tensor data structure and an irregular tensor data structure (Ragged Tensor). A tensor can be a multi-dimensional array, and the data types contained can be integers, floating-point numbers, and other representation types commonly used in computer processing. In the tensor data structure, the length of each dimension is determined. The irregular tensor data structure can be represented as a data structure with the concept of recursion. For example, an irregular tensor can be considered as a list of lists, and the list itself can also be a list of lists, thus dimensions of any length can be represented.

In some embodiments of the present disclosure, the relevant GPU can handle the regular tensor data structures. Therefore, in some embodiments of the present disclosure, processing is mainly performed on the sequence to be processed whose data structure is an irregular tensor data structure, and the sequence to be processed with an irregular tensor data structure is determined from multiple sequences input to the GPU.

In step S12, the data structure information included in the sequence to be processed is determined.

In some embodiments of the present disclosure, based on the above, the irregular tensor data structure is a multi-dimensional array. Through the irregular tensor data structure in the embodiments of the present disclosure, the data structure information included in the irregular tensor data structure can be determined. The data structure information may include tensor dimensions and element information included in the tensors of each dimension.

The GPU responds according to the sequence to be processed with the irregular tensor data structure, and determines the data structure information included in the irregular tensor data structure, so that when the data structure is converted, the targeted conversion can be performed.

In step S13, the irregular tensor data structure is converted into a regular tensor data structure, based on the tensor dimension and element information.

In embodiments of the present disclosure, based on the tensor dimension, the total number of elements included in the irregular tensor data structure can be determined. For example, with a 3-dimensional tensor data structure, if its dimension is 5*8*20, it represents that the tensor data structure includes a total of 5*8*20=800 elements. Based on the element information, the element value corresponding to each element, the row position of each element, and the number of elements can be determined. Herein, the number of elements is represented as the number of non-empty elements included in the irregular tensor data structure. In the process of converting an irregular tensor data structure into a regular tensor data structure, the number of elements included in the tensor data structure, the element value corresponding to each element and the row position of each element can be determined based on the tensor dimensions and element information included in the irregular tensor data structure, such that the sequence to be processed whose data structure is an irregular data structure can be expressed on the GPU, so that when the data structure is converted, the targeted conversion can be performed.

In step S14, the sequence to be processed is processed based on the regular tensor data structure.

In some embodiments of the present disclosure, through the basic operation algorithm related to the regular tensor data structure included in the GPU, the sequence to be processed whose data structure has become the regular tensor data structure is processed correspondingly such that when the GPU processes the sequence to be processed which has the irregular tensor data structure, a quick process can be performed without being transferred to the CPU for processing.

Through the above embodiments, when processing the sequence to be processed by the GPU, the sequence to be processed whose data structure is the irregular tensor structure can be converted into a corresponding regular tensor data structure in advance according to the data structure information included, such that when the GPU processes the sequence to be processed, the impact of the data structure of the sequence to be processed can be avoided or reduced, thereby enhancing the ability of the GPU to process the sequence. In addition, when processing the sequence to be processed with the irregular tensor structure, there is no need to transfer the sequence to the CPU, thereby avoiding the possibility of related data being contaminated during the transferring process, and keeping the data clean.

In some embodiments, in the process of converting an irregular tensor data structure into a regular tensor data structure, the number of corresponding regular data pairs can be determined according to the tensor dimension of the irregular tensor data structure. Based on the element information, the irregular tensor data structure is converted. Due to the irregular tensor data structure, multi-dimensional elements may appear in the same row of elements. In order to represent the correlation between the elements of respective dimensions, in the embodiments of the present disclosure, the data characteristics of the irregular tensor data structure can be determined, and the irregular tensor data structure can be converted into corresponding regular array pairs to represent an irregular tensor data structure through the regular array pairs. That is, when the irregular tensor data structure includes N tensor dimensions, based on element information, the irregular tensor data structure can be converted into N-1 regular array pairs. The irregular tensor data structure is regularized for dimensionality reduction such that the GPU can determine the correlation between the respective dimensional elements when processing the sequence to be processed, and quickly determine the data characteristics of the sequence to be processed, thereby facilitating to quickly perform processing to improve processing efficiency. For example, if the irregular tensor data structure includes 2 tensor dimensions, the irregular tensor data structure is converted into a regular array pair. If the irregular tensor data structure includes 4 tensor dimensions, the irregular tensor data structure is converted into 3 regular array pairs.

In some other embodiments, for the data structure of the N-dimensional irregular tensor in some embodiments of the present disclosure, the irregular tensor data structure can be converted into N-1 regular array pairs, based on element information. FIG. 2 is a flowchart showing a data structure converting process according to some embodiments.

In step S21, a number of elements included in the irregular tensor data structure is determined according to the element information.

In some embodiments of the present disclosure, according to the element information, it is possible to determine the element value corresponding to all the lowest-level elements contained in the irregular tensor data structure, the row position of each element, and the number of elements. The number of elements can be represented as the total number of elements included in the irregular tensor data structure. Through the number of elements, the length of the first array corresponding to the irregular tensor data structure can be determined, such that the converting can be performed quickly during converting. Herein, the element values in the first array are elements included in the irregular tensor data structure, and the array length of the first array is the number of elements included in the irregular tensor data structure.

In step S22, the first array included in the regular array pairs is determined.

In some embodiments of the present disclosure, the first array is used to represent all the lowest-level elements contained in the irregular tensor data structure. In the process of converting the irregular tensor data structure to the regular tensor data structure, the length of the first array is determined according to the determined number of elements, and then the respective lowest-level elements are collected to obtain the first array included in the regular array pairs.

In some possible implementation scenarios, taking the two-dimensional irregular tensor data structure as an example, the sequence to be processed is [[2 4][8][][6 1]]. According to the lowest-level contained elements being 2, 4, 8, 6, 1, and the determined number of elements being 5, it can be seen that in the first array, the values of the contained elements are 2, 4, 8, 6, 1. Respectively, the length of the first array is 5, that is, the determined first array is [2 4 8 6 1]. In an example, the values array can be used to represent the first array.

In step S23, the second array and/or the third array included in the regular array pairs are determined based on the first array.

In embodiments of the present disclosure, the regular data pairs may include at least one of the first array, the second array, and the third array, that is, the regular data pairs may include the following forms: the first array and the second array, the first array and the third array, and the first array, the second array and the third array. There can be multiple rays included in each type. The more arrays the regular array pairs include, the more complete the relationship between the respective elements is expressed with the irregular tensor data structure.

The second array is used to represent the row information of each element included in the first array in the irregular tensor data structure. That is, through the second array, a specific row position to which each element of the first array belongs in the irregular tensor data structure can be determined. Through the determined row position of each element in the first array, the second array corresponding to the irregular tensor data structure can be determined. In some possible implementation scenarios, if the first array is [2 4 8 6 1], 2 and 4 are elements of the 0^{th} row in the irregular tensor data structure, 8 is the element of the first row in the irregular tensor data structure, and 6 and 1 are the elements of the third row in the irregular tensor data structure, the determined second array is [0 0 1 3 3]. In an example, the row_ids array can be used to represent the second array.

The third array is used to represent the array length of the first array and starting position of the elements contained in each row of the irregular tensor data structure. That is, the length of the third array can be understood as one more than the number of rows in the irregular tensor data structure. The third array can be used to determine the row position of the starting element of each row in the first array and the number of elements included in the irregular tensor data structure. In some embodiments, row_splits arrays can be used to represent the third array. The third array can be determined by the row position of the starting element of each row in the first array and the number of elements included in the irregular tensor data structure. In some implementation examples, the element corresponding to the last element value in the third array is the number of elements, and the difference between the remaining adjacent elements can represent the number of elements included in previous rows. For example, if row_splits[2]-row_splits[1]=3−2=1, in the third array, the element value corresponding to the second row is 3, and the element value corresponding to the first row is 2. The difference between the elements in the second row and the first row is 1, which means that in the irregular tensor data structure, the row position of the starting element in the second row and the row position of the starting element in the first row in the first array differ by 1, so the first row includes 1 element. If row_splits[3]-row_splits[2]=6−2=4, in the third array, the element value corresponding to the third row is 6, and the element value corresponding to the second row is 2. The difference between the elements in the third row and the second row is 4, which means that in the irregular tensor data structure, the row position of the starting element in the third row and the row position of the starting element in the second row in the first array differ by 4, so the second row includes 4 elements. In some implementation scenarios, if the first array is [2 4 8 6 1], 2 is the starting element of the 0^{th} row, 8 is the starting element of the first row, 6 is the starting element of the second row, 1 is the starting element of the third row, and the number of elements is 5, then the third array obtained after converting the irregular tensor data structure is [0 2 3 4 5].

In some embodiments, when the second array is determined based on the first array, the row value of each element in the irregular tensor data structure can be determined respectively according to the elements contained in the first array, and the corresponding row position of each element in the first array in the irregular tensor data structure is determined respectively. The row value corresponding to each element in the first array is used as the element value corresponding to each row in the second array to form a second array whose array length is the number of elements included in the irregular tensor data structure. A second array with the same length as the first array is obtained, and each element value in the second array corresponds to each element value in the first array. In some implementation scenarios, if the first array corresponding to the irregular tensor data structure is [2 4 8 6 1], where the number of rows corresponding to 2 and 4 is the 0^{th} row, the number of rows corresponding to 8 is the first row, and the number of rows corresponding to 6 and 1 is the third row, then, the second data is [0 0 1 3 3].

In some other embodiments, when the third array is determined based on the first array, according to the data structure information of the irregular tensor data structure, the row starting element in each row of the irregular tensor data structure can be determined. According to the first array, the row value corresponding to each row starting element in the first array can be determined, and then the row value corresponding to the row starting element in the first array is used as the element value included in the third array in the order of rows, and the array length of the first array is used as the last element value of the third array. In some implementation scenarios, if the number of rows of the irregular tensor data structure is 3, the row starting element of the 0^{th} row is 4, the row starting element of the first row is 6, and the row starting element of the second row is 3. According to the first array being [4 7 5 6 2 8 3], the corresponding row value of 4 in the first array is 0, the row value of 6 in the first array is 3, and the row value of 3 is in the first array is 6. The array length of the first array is 7, so the last element value of the third array is 7. The third array is determined as [0 3 6 7].

In some examples, in response to the row starting element corresponding to the current row in the third array being empty, the element value of the adjacent row in the third array becomes the element value of the current row. That is, in the irregular tensor data structure, if the row starting element of a certain row is empty, the element value corresponding to the previous row or the next row can be used as the element value corresponding to the third array.

In some implementation scenarios, if the number of rows of the irregular tensor data structure is 3, the row starting element of the 0^{th} row is 4, the row starting element of the first row is empty, and the row starting element of the second row is 6. In the third array, the last element value corresponds to the data length of the first array, and the difference between the remaining adjacent elements can represent the number of elements included in each previous row. It can be known, from the first array being [4 7 5 6 2 8 3], that the corresponding row value of 4 in the first array is 0, the corresponding row value of 6 in the first array is 3, and the array length of the first array is 7, the element value corresponding to the row starting element of the second row in the third array can be used as the element value corresponding to the row starting element of the first row in the third array, and the last element value of the third array is 7. The third array is determined as [0 3 3 7].

In some embodiments, the third array may be determined by the first array and second array. The element information corresponding to the irregular tensor data structure is determined through the value of each element in the first array. Through the value of each element in the second array, the row information to which each element contained in the irregular tensor data structure belongs is determined. According to the meaning represented by each element value in the first array and the second array, the third array can be determined.

In yet other examples, the second array may be obtained based on the determined first array and third array. The element information corresponding to the irregular tensor data structure is determined through the value of each element in the first array. The starting position of the element contained in each row of the irregular tensor data structure in the first array is determined by the value of each element in the third array, and then the second array can be determined according to the respective elements contained in the first array. In some implementation scenarios, if the first array is [2 4 8 6 1], and the third array is [0 2 3 3 5], it can be determined that the number of rows of the irregular tensor data is 4, the number of elements is 5, 2 is the starting element of the 0^{th} row, 8 is the starting element of the first row, empty is the starting element of the second row, 6 is the starting element of the third row, and the corresponding second array obtained is [0 0 1 3 3].

In other examples, in the process of converting an irregular tensor data structure to a regular tensor data structure, the first array, the second array, and the third array can be directly obtained based on the tensor dimension and element information.

Based on a similar concept, the embodiments of the present disclosure also provide some basic operation algorithms applied to the GPU, such that the GPU can quickly process the irregular tensor data structure according to the algorithm and convert the irregular tensor data structure into required regular tensor data structure. The basic operation algorithm can include: RowSplitsToRowIds, where the row_splits array is given to calculate the corresponding row_ids array; RowIdsToRowSplits, where the row_ids array and the number of rows are given to calculate the corresponding row_splits array; ExclusiveSum (exclusive sum), where the exclusive-sum of the specified regular array is calculated, an example being the regular array is specified as [1 2 1 3] and its corresponding exclusive-sum array is [0 1 3 4], wherein, the exclusive-sum of each position in the original specified regular array does not include the element at its current position, for example, in the third row of the specified regular array, its current position element is 3, and its exclusive-sum value is 1+2+1=4, which does not include the current position element 3; SegmentedReduce, where a 2-dimensional irregular tensor data structure is given to calculate a Reduce value of each row, where Reduce is a binary operation, such as summation or maximum value and so on, and taking the Reduce operation as the summation as an example, SegmentedReduce means calculating the sum of elements of each row in an irregular tensor data structure, for example, for an irregular tensor data structure [[1 2][3][5 1 3]], its SegmentedReduce value (assuming that the Reduce operation is a summation) is [3 3 9]; and SegmentedSort, where a 2-dimensional irregular tensor data structure is given to sort the elements of each row according to the given comparison operator, for example, when assuming that Ragged Tensor [[1 0][3][5 1 3]] is sorted in ascending order, its value is [[0 1][3][1 3 5]]. In an example, when SegmentedReduce and SegmentedSort process an irregular tensor data structure, the tensor dimension of the irregular tensor data structure may not be restricted. In some implementation scenarios, the above-mentioned basic operation algorithm can be implemented using a productivity library for general-purpose computing, which is open sourced by GPUs such as moderngpu, cub, etc.

In related fields, when the GPU performs sequence processing related tasks, it can only process task groups with regular lengths, such as a task group with 1000 subtasks or 100*500 subtasks. Furthermore, when writing parallel code of GPU, a multi-layer loop code is usually used, causing time-consuming and low processing efficiency when the GPU runs according to the parallel code. Also, because the number of elements in each row of the irregular tensor data structure is different, the multi-layer loop coding method is adopted, and it cannot be converted into parallel code that can be used by the GPU.

In view of this, in some embodiments of the present disclosure, based on the above-mentioned basic operation algorithms, it is possible to convert the irregular tensor data structure into a one-dimensional regular array when programming in the GPU based on the irregular tensor data structure, such that when programming, the structure can be avoided or cycled to reduce the complexity of code writing, and the obtained code can be quickly converted into the parallel code that the GPU can run, thus improving the efficiency that GPU implements the related algorithms for the irregular tensor data structures.

In some implementation scenarios, taking a two-dimensional irregular tensor data structure as an example, the following code can be used for programming when calculating the modulo of the row number corresponding to each element in the irregular tensor data structure:

```
  for(int i = 0; i != num_values; ++i){
int row_id = row_ids[i]; // row_id represents the row number
    values[i] = values[i] % row_id;
      }
```

where i represents the row value corresponding to each element in the first array.

In other implementation scenarios, when programming based on irregular tensor data structures in GPU, one-dimensional regular arrays converted from the irregular tensor data structures and basic operation algorithms can also be quickly converted into the parallel code to be able to execute any of the following parallel instructions: Append, splicing a set of Ragged Tensor; Stack, stacking a set of Ragged Tensors with dimension n to form an irregular tensor data structure with dimension n+1, that is, for ans[i,j,k,l]=srcs[i][j,k,l], it is assumed that srcs is an input set of Ragged Tensor, and the dimension of each srcs[i] is 3, ans is the result of Stack; ChangeSublistSizes, changing the number of elements in each row of the input irregular tensor data structure; Prefix, getting the first n rows of the input irregular tensor data structure; RemoveAxis, removing the specified dimension in the irregular tensor data structure; Unsqueeze, adding a dimension to Ragged Tensor; Transpose, transposing the irregular tensor data structure; SubsampleRagged, retaining the specified elements in the irregular tensor data structure, and deleting the remaining elements; Index, getting a specified row in the irregular tensor data structure; RemoveValuesEq, removing all elements which are equal to a certain value in the irregular tensor data structure; RemoveValuesLeq, removing all elements in the irregular tensor data structure which are less than or equal to a certain value; and ComputeHash, calculating the Hash value of elements in each row in the irregular tensor data structure.

Based on the same concept, the embodiments of the present disclosure also provide another sequence processing method.

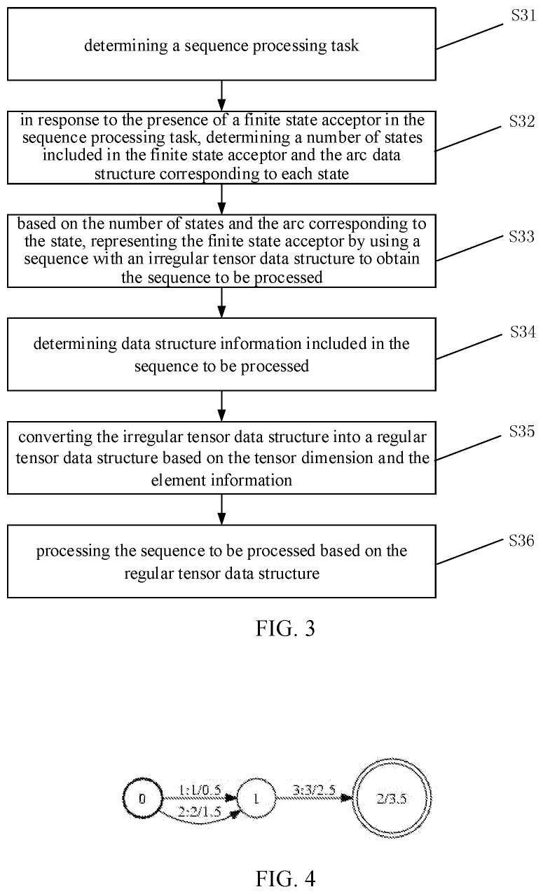

FIG. 3 is a flowchart showing a sequence processing method according to some embodiments. As shown in FIG. 3, the sequence processing method includes the following steps S31 to S36.

In step S31, a sequence processing task is determined.

In some embodiments of the present disclosure, in order to better clarify the processing required by the sequence to be processed, the sequence processing tasks that the GPU currently needs to perform are determined. Herein, the sequence processing task is a task that the graphics processor is controlled to perform sequence processing. In an example, the sequence processing task may include a sequence recognition task. For example, sequence recognition tasks can include tasks such as speech recognition, handwritten character recognition, natural language processing, etc.

In step S32, in response to the presence of a finite state acceptor in the sequence processing task, the number of states included in the finite state acceptor and the arc data structure corresponding to each state are determined.

In some embodiments of the present disclosure, when the GPU determines that there is a finite state acceptor in the sequence processing task according to the response, the number of states included in the finite state acceptor, and arc data structure corresponding to each state can be determined according to the existing finite state acceptor.

The finite state acceptor (FSA) is composed of a set of finite states and state transitions, each of which has at least one label. The finite state acceptor FSA may include: a weighted finite state acceptor (WFSA), where there is a weight for each state transition. That is, in each initial state, the initial weight is included, and in each termination state, the termination weight is included, and the weight can be represented as the probability or loss of the transition or the initial/termination state, and is accumulated along each path and accumulated in different paths. The finite state acceptor FSA is a directed graph. For example, in the change diagram of the finite state acceptor FSA shown in FIG. 4, for each state of the finite state acceptor FSA (each node in the directed graph), it can include arcs with unequal numbers taking this state as the starting point and point to other states, and then according to the change process of each state and the corresponding weight, can determine the arc data structure corresponding to each state. According to the number of rows contained in the irregular tensor data structure, the number of states of the finite state acceptor FSA can be determined.

In step S33, based on the number of states and the arcs corresponding to the states, the finite state acceptor is represented by using a sequence with an irregular tensor data structure to obtain the sequence to be processed.

In some embodiments of the present disclosure, the finite state acceptor can be represented by a sequence of irregular tensor data structures. Based on the number of states in the finite state acceptor FSA, the number of rows in the irregular tensor data structure can be determined, and the elements included in each row are determined based on the arc data structure in the state. In some implementation scenarios, as shown in FIG. 4, based on the number of states and the arcs corresponding to the states, the following sequence of the irregular tensor data structure is obtained:

row_splits array: [0, 2, 3, 3]
row_ids array: [0, 0, 1]
values array: [Arc{0,1,1,0,5}, Arc{0,1,2,1.5},Arc{1,2,3,2.5}].
where Arc can represent the state change process of the arc and the corresponding weight.

In step S34, the data structure information included in the sequence to be processed is determined.

In step S35, based on the tensor dimension and element information, the irregular tensor data structure is converted into a regular tensor data structure.

In step S36, the sequence to be processed is processed based on the regular tensor data structure.

In some embodiments, the data structure of the arc may include the starting state, target state, input label, and label weight of the current arc, and the starting state, target state, input label, and label weight are determined as the elements included in each row of the arc data structure. In some implementation scenarios, for example Arc{0,1,1,0.5}, it indicates that the starting state is 0, the target state is 1, the input label is 1, and the weight is 0.5 for the arc.

In another embodiment, the present disclosure also provides another sequence processing method, which can represent finite state transducers (FST) based on an irregular tensor data structure, such that the finite state transducer FST can be applied on GPU in the form of the irregular tensor data structure to realize the derivability of the irregular tensor data structure.

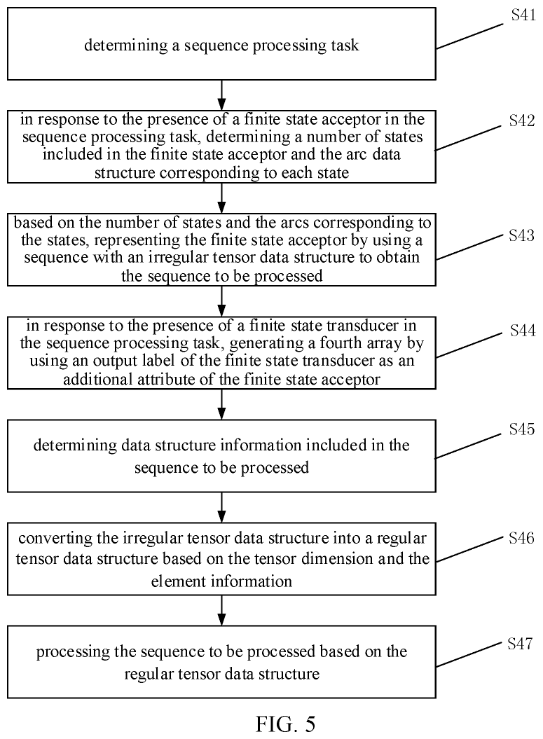

FIG. 5 is a flowchart showing a sequence processing method according to some embodiments. As shown in FIG. 5, the sequence processing method includes the following steps S41 to S47.

In step S41, the sequence processing task is determined.

In step S42, in response to the presence of a finite state acceptor in the sequence processing task, the number of states included in the finite state acceptor and the arc data structure corresponding to each state are determined.

In step S43, based on the number of states and the arcs corresponding to the states, the finite state acceptor is represented by using a sequence with an irregular tensor data structure to obtain the sequence to be processed.

In step S44, in response to the presence of the finite state transducer in the sequence processing task, a fourth array is generated by using the output label of the finite state transducer as an additional attribute of the finite state acceptor.

In some embodiments of the present disclosure, the finite state transducer (FST) is a finite state acceptor FSA, and in addition to the data included in the finite state acceptor FSA, it also includes an output label. In response to the presence of a finite state transducer in the sequence processing task, the output label of the finite state transducer is used as an additional attribute of the finite state acceptor to generate a fourth array. Herein, the number of elements included in the fourth array is the same as the number of arc data structures included in the state acceptor. In some examples, each element in the output label may correspond to each element in the input label. For example, if the values array of the finite state acceptor FSA is [Arc{0,1,1,0,5}, Arc{0,1,2,1.5}, Arc{1,2,3,2.5}], then the corresponding output label is stored as an array [1,2,3].

In step S45, the data structure information included in the sequence to be processed is determined.

In step S46, the irregular tensor data structure is converted into a regular tensor data structure based on the tensor dimension and element information.

In step S47, the sequence to be processed is processed based on the regular tensor data structure.

In some embodiments, the additional attributes can facilitate to realize the derivability of the finite state transducer FST, and the array pairs converted based on the irregular tensor data structure can facilitate the GPU to quickly perform related operations of sequence processing, thus improving the processing power of the GPU, and improving the processing effect. In some embodiments, the additional attributes may also include the following multiple attributes: TopSort, performing topological sorting on the finite state transducer FST; ArcSort, sorting the output arcs of each state in the finite state transducer FST; Intersection, an intersection algorithm of two FSTs; RemoveEpsilon, removing the Epsilon (usually represented by 0) label in the finite state transducer FST; ShortestPath, calculating the shortest path (from the initial state to the end state) in the finite state transducer FST; Closure, the closure algorithm of finite state transducer FST; and Invert, which is an inversion algorithm of the finite state transducer FST.

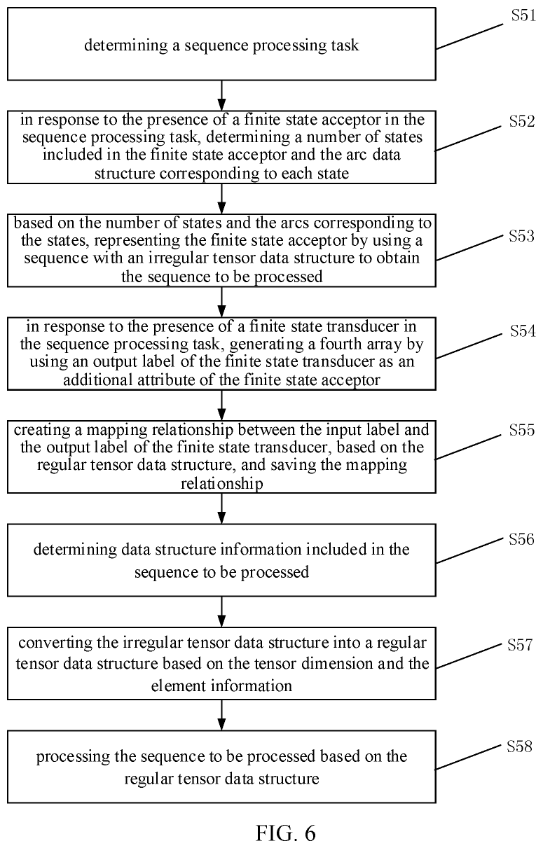

In another embodiment, FIG. 6 is a flowchart showing a sequence processing method according to some embodiments. As shown in FIG. 6, the sequence processing method includes the following steps S51 to S58.

In step S51, the sequence processing task is determined.

In step S52, in response to the presence of a finite state acceptor in the sequence processing task, the number of states included in the finite state acceptor and the arc data structure corresponding to each state are determined.

In step S53, based on the number of states and the arcs corresponding to the states, the finite state acceptor is represented by using a sequence with an irregular tensor data structure to obtain the sequence to be processed.

In step S54, in response to the presence of the finite state transducer in the sequence processing task, a fourth array is generated by using the output label of the finite state transducer as an additional attribute of the finite state acceptor.

In step S55, a mapping relationship based on the regular tensor data structure between the input label and the output label of the finite state transducer is created, and the mapping relationship is saved.

In some embodiments of the present disclosure, in order to facilitate the realization of the derivability of the finite state transducer FST, a mapping relationship based on the regular tensor data structure between the input label and the output label of the finite state transducer is created, and the mapping relationship is saved. Through this kind of mapping relationship, the gradient on the arc of the output finite state transducer FST can be back propagated to the output FST.

In step S56, the data structure information included in the sequence to be processed is determined.

In step S57, the irregular tensor data structure is converted into a regular tensor data structure based on the tensor dimension and element information.

In step S58, the sequence to be processed is processed based on the regular tensor data structure.

Through any of the above sequence processing methods, the irregular tensor data structure can be easily used to process any irregular tasks on the GPU. Further, based on the provided related operation algorithms and regularized converting of data structures, it is helpful to design and implement algorithms related to finite state acceptors related to irregular tensor data structures on the GPU to improve the practicability of the GPU.

In some implementation scenarios, based on any of the above sequence processing methods, the decoding task of processing speech recognition-related sequences in the GPU can be implemented.

Based on the same concept, the embodiments of the present disclosure also provide a sequence processing apparatus applied to a graphics processor.

It can be understood that, in order to implement the above-mentioned functions, the sequence processing apparatus provided by the embodiments of the present disclosure includes hardware structures and/or software modules corresponding to each function. In combination with the units and algorithm steps of the examples disclosed in some embodiments of the present disclosure, the embodiments of the present disclosure can be implemented in the form of hardware or a combination of hardware and computer software. Whether a certain function is executed by hardware or computer software-driven hardware depends on the specific application and design constraint conditions of the technical solution. Those skilled in technologies can use different methods for each specific application to implement the described functions, but such implementation should not be considered as going beyond the scope of the technical solutions of the embodiments of the present disclosure.

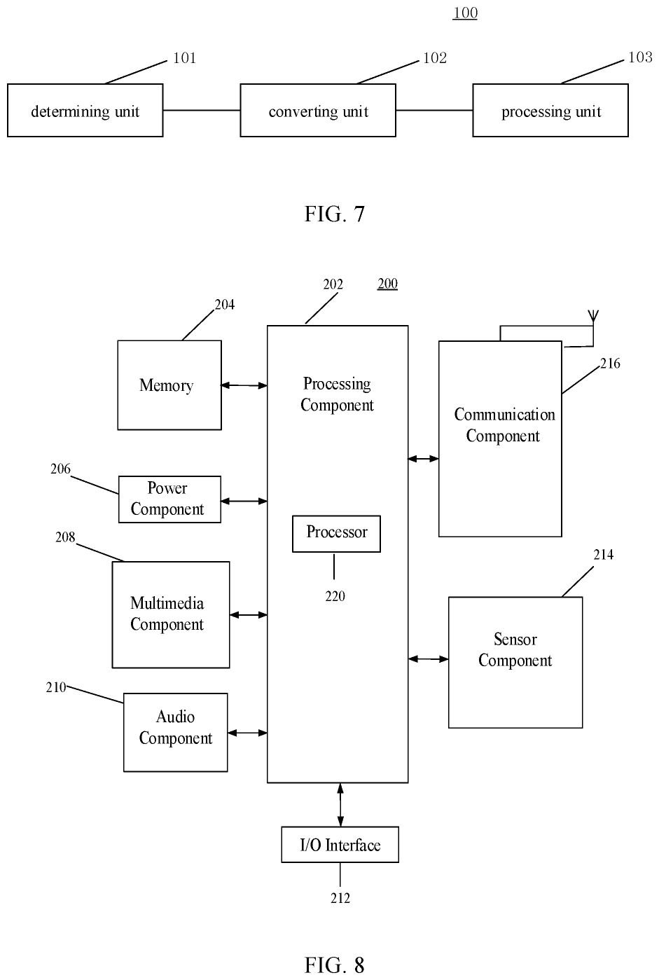

FIG. 7 is a block diagram showing a sequence processing apparatus according to some embodiments. Referring to FIG. 7, the sequence processing apparatus 100 includes a determining unit 101, a converting unit 102 and a processing unit 103.

The determining unit 101 is configured to determine the sequence to be processed and determine the data structure information included in the sequence to be processed, wherein the sequence to be processed has an irregular tensor data structure, and the data structure information includes tensor dimensions, and element information is included in the tensor of each dimension.

The converting unit 102 is configured to convert an irregular tensor data structure into a regular tensor data structure based on the tensor dimension and element information.

The processing unit 103 is configured to process the sequence to be processed based on the regular tensor data structure.

In an embodiment, the converting unit 102 is configured to convert the irregular tensor data structure into a regular tensor data structure based on the tensor dimension and element information in the following manner: in response to the irregular tensor data structure including N tensor dimensions, converting the irregular tensor data structure into N-1 regular array pairs based on the element information.

In another embodiment, the converting unit 102 is configured to convert the irregular tensor data structure into N-1 regular array pairs based on element information in the following manner: determining a number of elements included in the irregular tensor data structure according to the element information; determining a first array included in the regular array pairs, the element values in the first array being elements included in the irregular tensor data structure, and an array length of the first array being the number of elements included in the irregular tensor data structure; and determining a second array and/or a third array included in the regular array pairs based on the first array, where the second array is used to represent row information of each of the elements included in the first array in the irregular tensor data structure; and the third array is used to represent the starting position of the elements contained in each row of the irregular tensor data structure in the first array, and the array length of the first array.

In another embodiment, the converting unit 102 is configured to determine the second array included in the regular array pair based on the first array in the following manner: determining a row value to which each element value in the first array belongs in the irregular tensor data structure; and using the row value as the element value corresponding to each row in the second array to form a second array whose array length is the number of elements included in the irregular tensor data structure.

In another embodiment, the converting unit 102 is configured to determine the third array included in the regular array pairs based on the first array in the following manner: determining a row starting element in each row in the irregular tensor data structure, and determining the row value corresponding to the row starting element in the first array; and using the row value corresponding to the row starting element in the first array as the element value included in the third array in order of rows, and using the array length of the first array as the last element value of the third array.

In another embodiment, if the row starting element corresponding to the current row in the third array is empty, the element value of an adjacent row in the third array is used as the element value of the current row.

In another embodiment, before determining the sequence to be processed, the determining unit 101 is further configured to: determine a sequence processing task, and the sequence processing task is a task for controlling the graphics processor to perform sequence processing. The determining unit 101 is configured to determine the sequence to be processed in the following manner: in response to the presence of a finite state acceptor in the sequence processing task, determining a number of states included in the finite state acceptor and the arc data structure corresponding to each state; and based on the number of states and the arc corresponding to the state, representing the finite state acceptor by using a sequence with an irregular tensor data structure to obtain the sequence to be processed. Herein, the number of rows in the irregular tensor data structure is determined by the number of states, and the elements included in each row are determined based on the arc data structure in the state.

In another embodiment, the elements included in each row are determined based on the arc data structure in the state in the following manner: determining a starting state, a target state, an input label, and a label weight included in the arc data structure as the elements included in each row.

In yet another embodiment, the converting unit 102 is further configured to: in response to the presence of a finite state transducer in the sequence processing task, generate a fourth array by using an output label of the finite state transducer as an additional attribute of the finite state acceptor. The number of elements included in the fourth array is the same as the number of arc data structures included in the state acceptor.

In yet another embodiment, the sequence processing apparatus further includes: a creating unit configured to create a mapping relationship between the input label and the output label of the finite state transducer, based on the regular tensor data structure, and save the mapping relationship.

With respect to the apparatuses in the above embodiments, the specific manners for performing operations for individual modules therein have been described in detail in the embodiments regarding the methods, which will not be elaborated.

FIG. 8 is a block diagram showing another sequence processing device according to some embodiments. For example, the sequence processing device 200 can be a mobile phone, a computer, a digital broadcast terminal, a messaging device, a gaming console, a tablet, a medical device, exercise equipment, a personal digital assistant, etc.

Referring to FIG. 8, the sequence processing device 200 can include one or more of the following components: a processing component 202, a memory 204, a power component 206, a multimedia component 208, an audio component 210, an input/output (I/O) interface 212, a sensor component 214, and a communication component 216.

The processing component 202 typically controls overall operations of the sequence processing device 200, such as the operations associated with display, telephone calls, data communications, camera operations, and recording operations. The processing component 202 can include one or more processors 220 to execute instructions to perform all or part of the steps in the described methods above. Moreover, the processing component 202 can include one or more modules which facilitates the interaction between the processing component 202 and other components. For instance, the processing component 202 can include a multimedia module to facilitate the interaction between the multimedia component 208 and the processing component 202.

The memory 204 is configured to store various types of data to support the operation of the sequence processing device 200. Examples of such data include instructions for any applications or methods operated on the sequence processing device 200, contact data, phonebook data, messages, pictures, video, etc. The memory 204 can be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 206 provides power to various components of the sequence processing device 200. The power component 206 can include a power management system, one or more power sources, and any other components associated with the generation, management, and distribution of power in the sequence processing device 200.

The multimedia component 208 includes a screen providing an output interface between the sequence processing device 200 and the user. In some embodiments, the screen can include a liquid crystal display (LCD) and a touch panel (TP). In some implementations, an organic light-emitting diode (OLED) display can be employed.

If the screen includes the touch panel, the screen can be implemented as a touch screen to receive input signals from the user. The touch panel includes one or more touch sensors to sense touches, swipes, and gestures on the touch panel. The touch sensors can not only sense a boundary of a touch or swipe action, but also sense a period of time and pressure associated with the touch or swipe action. In some embodiments, the multimedia component 208 includes a front camera and/or a rear camera. The front camera and/or the rear camera can receive an external multimedia datum while the sequence processing device 200 is in an operation mode, such as a photographing mode or a video mode. Each of the front camera and the rear camera can be a fixed optical lens system or have focus and optical zoom capability.

The audio component 210 is configured to output and/or input audio signals. For example, the audio component 210 includes a microphone (“MIC”) configured to receive an external audio signal when the sequence processing device 200 is in an operation mode, such as a call mode, a recording mode, and a voice recognition mode. The received audio signal can be further stored in the memory 204 or transmitted via the communication component 216. In some embodiments, the audio component 210 further includes a speaker to output audio signals.

The I/O interface 212 provides an interface between the processing component 202 and peripheral interface modules, such as a keyboard, a click wheel, buttons, etc. The buttons can include, but are not limited to, a home button, a volume button, a starting button, and a locking button.

The sensor component 214 includes one or more sensors to provide status assessments of various aspects of the sequence processing device 200. For instance, the sensor component 214 can detect an open/closed status of the sequence processing device 200, relative positioning of components, e.g., the display and the keypad, of the sequence processing device 200, a change in position of the sequence processing device 200 or a component of the sequence processing device 200, a presence or absence of user contact with the sequence processing device 200, an orientation or an acceleration/deceleration of the sequence processing device 200, and a change in temperature of the sequence processing device 200. The sensor component 214 can include a proximity sensor configured to detect the presence of nearby objects without any physical contact. The sensor component 214 can also include a light sensor, such as a CMOS or CCD image sensor, for use in imaging applications. In some embodiments, the sensor component 214 can also include an accelerometer sensor, a gyroscope sensor, a magnetic sensor, a pressure sensor, or a temperature sensor.

The communication component 216 is configured to facilitate wired or wireless communication between the sequence processing device 200 and other devices. The sequence processing device 200 can access a wireless network based on a communication standard, such as Wi-Fi, 2G, 3G, 4G, or 5G or a combination thereof. In some embodiments, the communication component 216 receives a broadcast signal or broadcast associated information from an external broadcast management system via a broadcast channel. In one exemplary embodiment, the communication component 216 includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the sequence processing device 200 can be implemented with one or more application specific integrated circuits (ASICs), digital signal processors (DSPs), digital signal processing sequence processing devices (DSPDs), programmable logic sequence processing devices (PLDs), field programmable gate arrays (FPGAs), controllers, micro-controllers, microprocessors, or other electronic components, for performing any of the sequence processing methods described above.

In exemplary embodiments, there is also provided a non-transitory computer-readable storage medium including instructions, such as included in the memory 204, executable by the processor 220 in the sequence processing device 200, for performing the above-described methods. For example, the non-transitory computer-readable storage medium can be a ROM, a random access memory (RAM), a CD-ROM, a magnetic tape, a floppy disc, an optical data storage sequence processing device, etc.

It can be further understood that in the present disclosure, “multiple” refers to two or more, and other quantifiers are similar. “And/or” describes the relationship of the associated objects, indicating that there can be three types of relationships, for example, A and/or B may indicate three cases: A exists alone, A and B exist simultaneously, and B exists alone. The character “/” generally indicates that the associated objects before and after are in an “or” relationship. The singular forms “a”, “an”, “said” and “the” are also intended to include plural forms, unless the context clearly indicates other meanings.

It can be further understood that the terms “first”, “second”, etc. are used to describe various information, but the information should not be limited to these terms. These terms are only used to distinguish the same type of information from each other, and do not indicate a specific order or degree of importance. In fact, expressions such as “first” and “second” can be used interchangeably. For example, without departing from the scope of the present disclosure, the first information may also be referred to as second information, and similarly, the second information may also be referred to as first information.

It can be further understood that, unless otherwise specified, “connection” includes a direct connection between the two without other components, and also includes an indirect connection between the two with other elements.

It can be further understood that, although the operations are described in a specific order in the drawings in some embodiments of the present disclosure, they should not be understood as requiring these operations to be performed in the specific order shown or in a serial order, or requiring all the shown operations to be performed to obtain the desired result. In certain circumstances, multitasking and parallel processing may be advantageous.

Various embodiments of the present disclosure can have one or more of the following advantages.

Through the method provided by the present disclosure, in the case that the sequence to be processed has an irregular tensor data structure, the irregular tensor data structure is converted into a regular tensor data structure according to the data structure information included in the irregular tensor data structure, such that GPU can quickly process the sequence to be processed which is converted into the regular tensor data structure and optimize the ability of GPU to process the sequence, so as to speed up the processing process and improve the efficiency of GPU to process the sequence.

The various device components, units, circuits, blocks, or portions may have modular configurations, or are composed of discrete components, but nonetheless may be referred to as “modules,” “components” or “circuits” in general. In other words, the components, units, circuits, blocks, or portions referred to herein may or may not be in modular forms, and these phrases may be interchangeably used.

The various device components, units, blocks, portions, or modules may be realized with hardware, software, or a combination of hardware and software.

In some embodiments of the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms In some embodiments of the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In some embodiments of the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or retracted from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

What is claimed is:

1. A sequence processing method, applied to a graphics processor, comprising:
determining a sequence to be processed, which has an irregular tensor data structure;
determining data structure information in the sequence to be processed, where the data structure information includes tensor dimensions and element information in tensors of each dimension;
converting the irregular tensor data structure into a regular tensor data structure based on the tensor dimension and the element information; and
processing the sequence to be processed based on the regular tensor data structure.

2. The sequence processing method according to claim 1, wherein said converting the irregular tensor data structure into a regular tensor data structure based on the tensor dimension and the element information comprises:
when the irregular tensor data structure includes N tensor dimensions, converting the irregular tensor data structure into N-1 regular array pairs based on the element information.

3. The sequence processing method according to claim 2, wherein said converting the irregular tensor data structure into N-1 regular array pairs based on the element information comprises:
determining a number of elements in the irregular tensor data structure according to the element information;
determining a first array in the regular array pairs, element values in the first array being elements in the irregular tensor data structure, and an array length of the first array being the number of elements in the irregular tensor data structure; and
determining a second array and/or a third array in the regular array pairs based on the first array,
wherein, the second array is used to represent row information of each of the elements in the first array in the irregular tensor data structure; and
the third array is used to represent a starting position of the elements in each row of the irregular tensor data structure in the first array, and the array length of the first array.

4. The sequence processing method according to claim 3, wherein said determining the second array in the regular array pairs based on the first array comprises:
determining a row value to which each element value in the first array belongs in the irregular tensor data structure; and
using the row value as the element value corresponding to each row in the second array to form a second array whose array length is the number of elements in the irregular tensor data structure.

5. The sequence processing method according to claim 3, wherein said determining the third array in the regular array pairs based on the first array comprises:
determining a row starting element in each row in the irregular tensor data structure, and determining a row value corresponding to the row starting element in the first array; and
using the row value corresponding to the row starting element in the first array as the element value in the third array in order of rows, and using the array length of the first array as the last element value of the third array.

6. The sequence processing method according to claim 5, wherein when the row starting element corresponding to the current row in the third array is empty, the element value of an adjacent row in the third array is used as the element value of the current row.

7. The sequence processing method according to claim 1, wherein:
prior to said determining the sequence to be processed, the method further comprises:
determining a sequence processing task, which is a task for controlling the graphics processor to perform sequence processing, and
the determining the sequence to be processed comprises:
in response to the presence of a finite state acceptor in the sequence processing task, determining a number of states in the finite state acceptor and an arc data structure corresponding to each state; and
based on the number of states and arcs corresponding to the states, representing the finite state acceptor by using a sequence with an irregular tensor data structure to obtain the sequence to be processed,
wherein the number of rows in the irregular tensor data structure is determined by the number of states, and the elements in each row are determined based on the arc data structure in the state.

8. The sequence processing method according to claim 7, wherein the elements in each row are determined based on the arc data structure in the state by:
determining a starting state, a target state, an input label, and a label weight in the arc data structure as the elements in each row.

9. The sequence processing method according to claim 7, further comprising:
in response to the presence of a finite state transducer in the sequence processing task, generating a fourth array by using an output label of the finite state transducer as an additional attribute of the finite state acceptor,
a number of elements in the fourth array being the same as a number of arc data structures in the state acceptor.

10. The sequence processing method according to claim 7, further comprising:
creating a mapping relationship between an input label and an output label of the finite state transducer, based on the regular tensor data structure, and saving the mapping relationship.

11. A sequence processing apparatus, applied to a graphics processor, comprising:
a memory device, configured to store processor-executable instructions; and
a processor, configured to:
determine a sequence to be processed, and determine data structure information in the sequence to be processed, wherein the sequence to be processed has an irregular tensor data structure, and the data structure information includes tensor dimensions and element information in tensors of each dimension;
convert the irregular tensor data structure into a regular tensor data structure based on the tensor dimension and the element information; and
process the sequence to be processed, based on the regular tensor data structure.

12. The sequence processing apparatus according to claim 11, wherein the processor is further configured to:
in response to the irregular tensor data structure including N tensor dimensions, convert the irregular tensor data structure into N-1 regular array pairs based on the element information.

13. The sequence processing apparatus according to claim 12, wherein the processor is further configured to convert the irregular tensor data structure into N-1 regular array pairs based on the element information by:
determining a number of elements in the irregular tensor data structure according to the element information;
determining a first array in the regular array pairs, element values in the first array being elements in the irregular tensor data structure, and an array length of the first array being the number of elements in the irregular tensor data structure; and
determining a second array and/or a third array in the regular array pairs based on the first array,
wherein the second array is used to represent row information of each of the elements in the first array in the irregular tensor data structure; and
the third array is used to represent a starting position of the elements in each row of the irregular tensor data structure in the first array, and the array length of the first array.

14. The sequence processing apparatus according to claim 13, wherein the processor is further configured to determine the second array in the regular array pairs based on the first array by:
determining a row value to which each element value in the first array belongs in the irregular tensor data structure; and
using the row value as the element value corresponding to each row in the second array to form a second array whose array length is the number of elements in the irregular tensor data structure.

15. The sequence processing apparatus according to claim 13, wherein the processor is further configured to determine the third array in the regular array pairs based on the first array by:
determining a row starting element in each row in the irregular tensor data structure, and determining a row value corresponding to the row starting element in the first array; and
using the row value corresponding to the row starting element in the first array as the element value in the third array in order of rows, and using the array length of the first array as the last element value of the third array.

16. The sequence processing apparatus according to claim 15, wherein when the row starting element corresponding to the current row in the third array is empty, the element value of an adjacent row in the third array is used as the element value of the current row.

17. The sequence processing apparatus according to claim 11, wherein:
prior to determining the sequence to be processed, the processor is further configured to:
determine a sequence processing task, which is a task for controlling the graphics processor to perform sequence processing, and
the processor is configured to determine the sequence to be processed by:
in response to the presence of a finite state acceptor in the sequence processing task, determining a number of states in the finite state acceptor and an arc data structure corresponding to each state; and
based on the number of states and an arc corresponding to the state, representing the finite state acceptor by using a sequence with an irregular tensor data structure to obtain the sequence to be processed,
wherein the number of rows in the irregular tensor data structure is determined by the number of states, and the elements in each row are determined based on the arc data structure in the state.

18. The sequence processing apparatus according to claim 17, wherein the processor is further configured to:
in response to the presence of a finite state transducer in the sequence processing task, generate a fourth array by using an output label of the finite state transducer as an additional attribute of the finite state acceptor,
a number of elements in the fourth array being the same as a number of arc data structures in the state acceptor.

19. The sequence processing apparatus according to claim 17, wherein the processor is further configured to:
create a mapping relationship between an input label and an output label of the finite state transducer, based on the regular tensor data structure, and save the mapping relationship.

20. A non-transitory computer-readable storage medium having stored thereon instructions for execution by a processor to implement a sequence processing method, applied to a graphics processor, comprising:
determining a sequence to be processed, which has an irregular tensor data structure;
determining data structure information in the sequence to be processed, where the data structure information includes tensor dimensions and element information in tensors of each dimension;
converting the irregular tensor data structure into a regular tensor data structure based on the tensor dimension and the element information; and
processing the sequence to be processed based on the regular tensor data structure.
